(19) United States
(12) Patent Application Publication
(10) Pub. No.: US 2011/0234380 A1
(43) Pub. Date: Sep. 29, 2011

(54) DATA COLLECTION SYSTEM AND WIRELESS TAG

(75) Inventor: Hisahiro ITO, Minowa-machi (JP)

(73) Assignee: SEIKO EPSON CORPORATION, TOKYO (JP)

(21) Appl. No.: 13/015,130

(22) Filed: Jan. 27, 2011

(30) Foreign Application Priority Data
Mar. 26, 2010 (JP) 2010-073418

(51) Int. Cl. G06K 7/01

(52) U.S. Cl. 340/10.2

(57) ABSTRACT

A data collection system includes: a plurality of wireless tags; and a data collection device that performs time-division multiplexing communication with the plurality of wireless tags, the wireless tag including a tag-side transmission unit that transmits a signal in a frequency band higher than the LF band to the data collection device, a tag-side reception unit that receives an LF signal transmitted from the data collection device, a timer that performs time measurement, and a storage that stores information.

### BACKGROUND

1. Technical Field

The present invention relates to a data collection system and a wireless tag.

2. Related Art

When wireless communication is performed between a plurality of client wireless transmitters and one host wireless transceiver, it is necessary to prevent a collision (crosstalk) of communication between each client wireless transmitter and the host wireless transceiver.

Japanese Patent No. 4284513 discloses a data collection system which is a system that prevents the collision of communication. In the data collection system, each client wireless transceiver determines the communication time on a random basis so as to avoid a collision of communication between each client wireless transceiver and the host wireless transceiver.

The data collection system disclosed in Japanese Patent No. 4284513 may be able to suppress the collision of communication. However, since the communication times determined randomly by the respective wireless transceivers may coincide with each other, it may be not possible to completely avoid the collision of communication.

The use of a communication scheme called time-division multiplexing communication may enable prevention of the collision of communication between each client wireless transmitter and the host wireless transceiver. However, this communication scheme has a problem in that power consumption is high. This is particularly so when battery-embedded wireless tags are used as the client wireless transmitters. In this case, there is a problem in that as the power consumption in the wireless tags increases, the batteries lose a large amount of energy and will not have a long lifespan.

### SUMMARY

An advantage of some aspects of the invention is to provide a data collection system and a wireless tag capable of reducing power consumption in the wireless tags and preventing a collision of communication between a plurality of wireless tags and a data collection device.

The invention solves at least a part of the above-described problems and can be implemented as the following forms or application examples.

### Application Example 1

According to this application example of the invention, there is provided a data collection system including a plurality of wireless tags; and a data collection device that performs time-division multiplexing communication with the plurality of wireless tags. The data collection device includes a collection device-side transmission unit that is provided on a gate or in the vicinity of the gate so as to transmit an LF signal in a low-frequency band (LF band) to the wireless tag, a collection device-side reception unit that receives a signal in a frequency band higher than the LF band transmitted from the wireless tag, a time information generator that generates time information representing time, and a time slot number information generator that generates time slot number information representing a time slot number which represents a time zone where data can be transmitted from the wireless tag to the data collection device. The wireless tag includes a tag-side transmission unit that transmits a signal in a frequency band higher than the LF band to the data collection device, a tag-side reception unit that receives an LF signal transmitted from the data collection device, a timer that performs time measurement, and a storage that stores information. The data collection device transmits the time slot number information and time information representing a current time to the wireless tag using the collection device-side transmission unit when the wireless tag passes through the gate. The wireless tag receives the time slot number information and the time information using the tag-side reception unit, stores the time slot number information in the storage, corrects time measurement information of the timer based on the time information to cause the timer to perform time measurement, and transmits data to the data collection device using the tag-side transmission unit in a time zone corresponding to the time slot number.

According to this configuration, since time-division multiplexing wireless communication (time-division multiplexing communication) is performed between the plurality of wireless tags and the data collection device, it is possible to prevent a collision of communication between each wireless tag and the data collection device.

Moreover, the communication in the LF band has low reception power consumption, and the wireless tag uses the communication (LF communication) in the LF band for reception and the communication in the frequency band higher than the LF band for transmission. Thus, the power consumption of the wireless tag can be reduced, and the lifespan of a power unit such as a battery embedded (mounted) therein can be extended.

### Application Example 2

The data collection system is preferably configured such that ID information of the wireless tag is stored in the storage, and the wireless tag is configured to transmit the ID information to the data collection device using the tag-side transmission unit in a time zone corresponding to the time slot number.

According to this configuration, management such as office management can be performed.

### Application Example 3

The data collection system is preferably configured such that the wireless tag includes a sensor that detects a physical quantity, and the wireless tag is configured to transmit the result of the detection by the sensor to the data collection device together with the ID information using the tag-side transmission unit in a time zone corresponding to the time slot number.

According to this configuration, it is possible to broaden the applications of the data collection system.

### Application Example 4

The data collection system is preferably configured such that a management area which is managed by the data collection device and to/from which entering and exiting through the gate is allowed is set, and the data collection device includes a determination unit that determines whether or not the wireless tag is positioned in the management area.

According to this configuration, management such as office management can be performed in a more reliable manner.

### Application Example 5

The data collection system is preferably configured such that a management area which is managed by the data collection device and to/from which entering and exiting through the gate is allowed is set, the gate includes an inner gate that is positioned close to the management area and an outer gate that is positioned on a side of the inner gate opposite the management area, the collection device-side transmission unit includes a first transmission unit that is provided on the inner gate or in the vicinity of the inner gate and a second transmission unit that is provided on the outer gate or in the vicinity of the outer gate, the collection device-side reception unit includes a first reception unit that is provided on the inner gate or in the vicinity of the inner gate and a second reception unit that is provided on the outer gate or in the vicinity of the outer gate, and the data collection device includes a movement direction determination unit that determines a movement direction of the wireless tag based on information received by the collection device-side reception unit when the wireless tag passes through the gate.

According to this configuration, management such as office management can be performed in a more reliable manner.

### Application Example 6

The data collection system is preferably configured such that a first management area and a second management area which are managed by the data collection device and which are separated by a distance such that signals in a frequency band higher than the LF band do not interfere with each other are set, and the time slot numbers are set to be shared by the wireless tag positioned in the first management area and the wireless tag positioned in the second management area.

According to this configuration, the time slot numbers can be effectively used.

### Application Example 7

According to this application example of the invention, there is provided a wireless tag that performs time-division multiplexing communication with a data collection device, including: a tag-side transmission unit that transmits a signal in a frequency band higher than a low-frequency (LF) band to the data collection device; a tag-side reception unit that receives an LF signal transmitted from the data collection device; a timer that performs time measurement; and a storage that stores information.

According to this configuration, since time-division multiplexing wireless communication (time-division multiplexing communication) is performed between the plurality of wireless tags and the data collection device, it is possible to prevent a collision of communication between each wireless tag and the data collection device.

Moreover, the wireless tag uses the communication (LF communication) in the LF band for reception and the communication in the frequency band higher than the LF band for transmission. Thus, the power consumption of the wireless tag can be reduced, and the lifespan of a power unit such as a battery embedded (mounted) therein can be extended.

### Application Example 8

The wireless tag is preferably configured to include a sensor that detects a physical quantity.

According to this configuration, when the wireless tag is used in a data collection system, the applications can be broadened.

### BRIEF DESCRIPTION OF THE DRAWINGS

The invention will be described with reference to the accompanying drawings, wherein like numbers reference like elements.

FIG. 1 is a block diagram showing a first embodiment in which a data collection system of the invention is applied to an office management system.

FIG. 2 is a diagram schematically showing the office management system shown in FIG. 1.

FIG. 3 is a diagram showing time slots in the office management system shown in FIG. 1.

FIG. 4 is a diagram illustrating the operation of the office management system shown in FIG. 1.

FIG. 5 is a diagram illustrating the operation of the office management system shown in FIG. 1.

FIG. 6 is a block diagram showing another configuration example of the office management system shown in FIG. 1.

FIG. 7 is a diagram schematically showing a second embodiment in which the data collection system of the invention is applied to an office management system.

FIG. 8 is a diagram showing time slots in the office management system shown in FIG. 7.

FIG. 9 is a diagram schematically showing a second embodiment in which the data collection system of the invention is applied to an office management system.

FIG. 10 is a diagram showing time slots in the office management system shown in FIG. 9.

FIG. 11 is a diagram schematically showing a third embodiment, in which the data collection system of the invention is applied to an office management system, showing the configuration in the vicinity of a gate.

### DESCRIPTION OF EXEMPLARY EMBODIMENTS

Hereinafter, a data collection system and a wireless tag according to the invention will be described in detail based on embodiments shown in the accompanying drawings.

In the following embodiments, a case where the data collection system and the wireless tag according to the invention are applied to an office management system will be described as a representative example. In addition, a case where a UHF band is used as a representative frequency band higher than a LF band will be described.

### First Embodiment

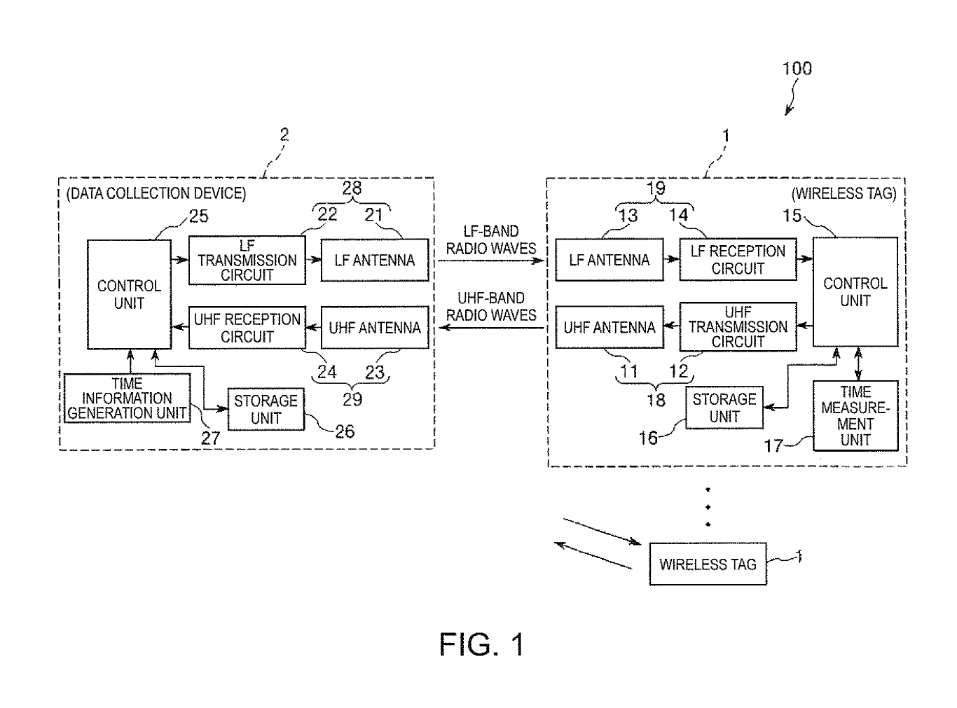

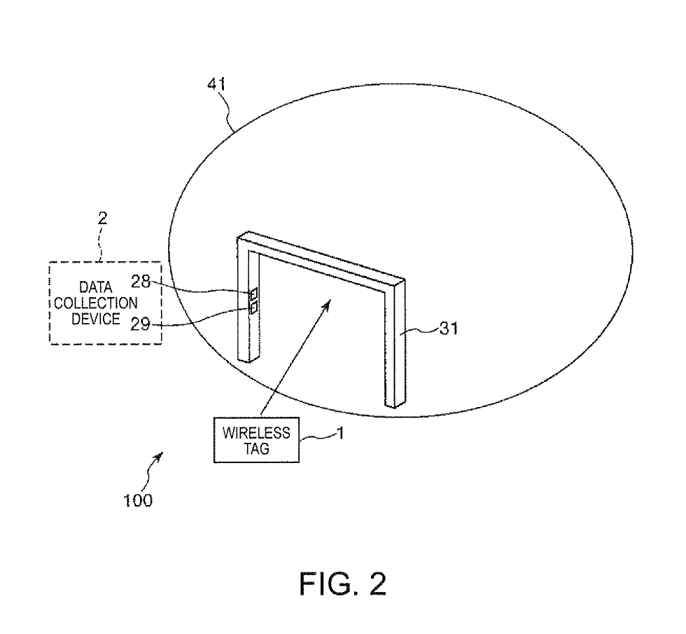

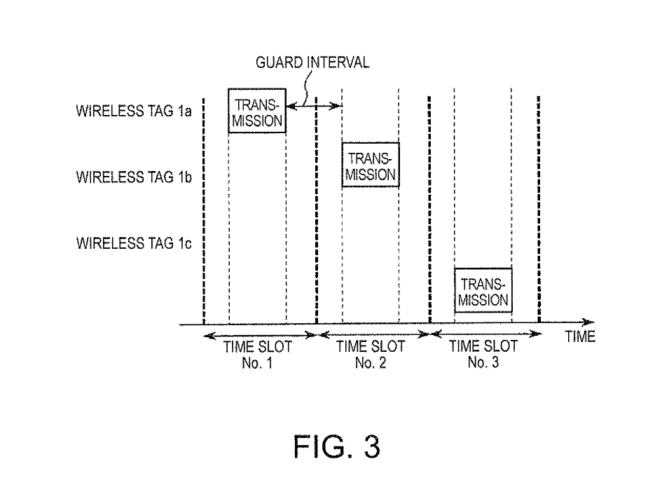

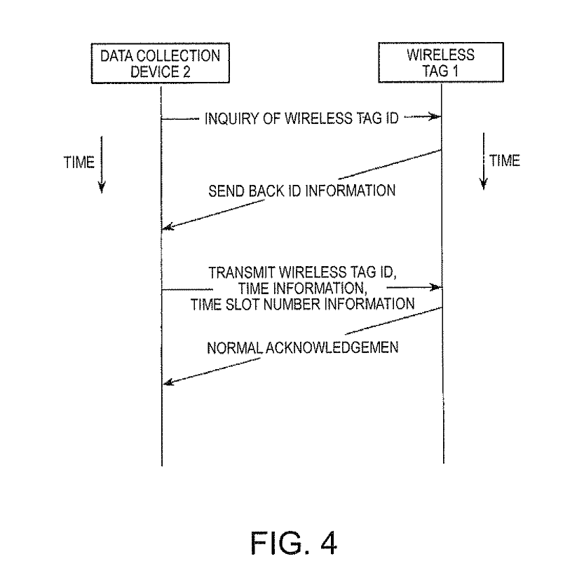

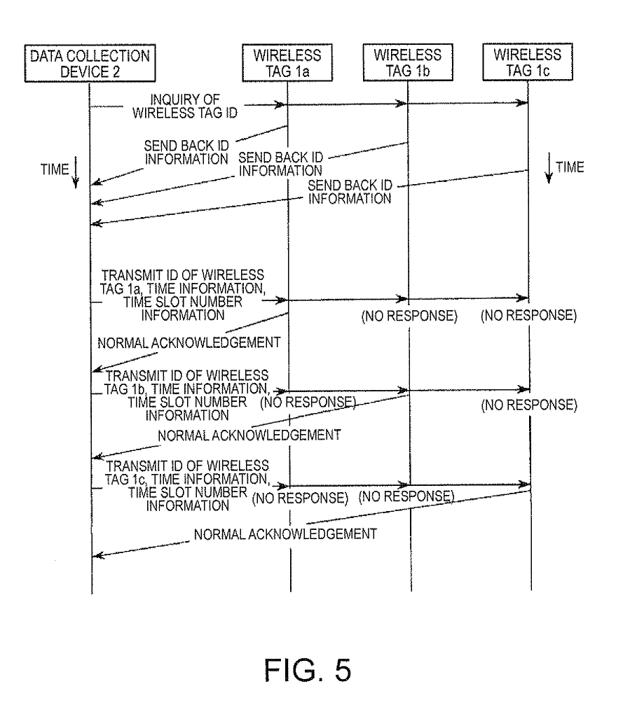

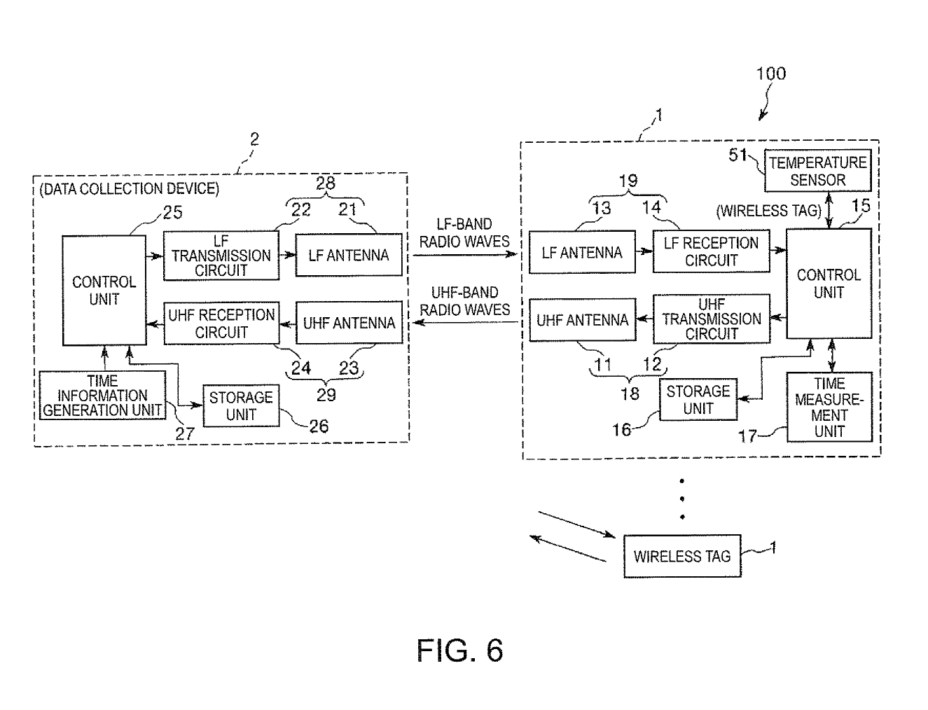

FIG. 1 is a block diagram showing a first embodiment in which a data collection system of the invention is applied to an office management system. FIG. 2 is a diagram schematically showing the office management system shown in FIG. 1. FIG. 3 is a diagram showing time slots in the office management system shown in FIG. 1. FIGS. 4 and 5 are diagrams illustrating the operation of the office management system shown in FIG. 1. FIG. 6 is a block diagram showing another configuration example of the office management system shown in FIG. 1.

An office management system 100 shown in FIG. 1 includes a plurality of wireless tags 1 and a data collection device 2, and time-division multiplexing wireless communication (time-division multiplexing communication) is performed between each wireless tag 1 and the data collection device 2. Each wireless tag 1 is distributed to each worker and held by the worker. The number of wireless tags 1 is not particularly limited but may be appropriately changed (set) in accordance with various situations such as the number of workers. Strictly speaking, although a wireless tag 1 moves when the worker holding the wireless tag 1 moves, in the following description, this will be simply expressed as “wireless tag 1 moves.”

The data collection device 2 manages a management area 41 of an office or the like where workers are allowed to enter and exit through a gate (entrance) (See FIG. 2). The data collection device 2 includes an LF (low frequency) antenna 21 and an LF transmission circuit 22. The data collection device 2 also includes an LF transmission unit (collection device-side transmission unit) 28 that transmits an LF signal to the wireless tags 1, a UHF (ultra-high frequency) antenna 23, and a UHF reception circuit 24. The data collection device 2 further includes a UHF reception unit (collection device-side reception unit) 29 that receives a UHF signal (having a frequency higher than the LF band) transmitted from any one of the wireless tags 1, a control unit (controller) 25, a storage unit (storage) 26 that stores information, and a time information generation unit (time information generator) 27 that generates time information that represents time (time interval).

The time information generation unit 27 may be a device that obtains time information, for example, using a high-precision timepiece (such as an atomic timepiece), the Internet, and the like.

Moreover, the control unit 25 is configured, for example, by a microcomputer or the like which includes a CPU, a ROM, a RAM, and the like. The control unit 25 performs various arithmetic and determination processes in the data collection device 2 and controls an overall operation of the data collection device 2. The control unit 25 achieves the main function of a determination unit.

The LF transmission unit 28, the UHF reception unit 29, the control unit 25, the storage unit 26, and the time information generation unit 27 which form the data collection device 2 may be disposed at one location and may be distributed over a plurality of locations.

In this case, the LF transmission unit 28 is provided on the gate 31 or in the vicinity of the gate 31. In this embodiment, the LF transmission unit 28 is provided on the gate 31.

Moreover, the UHF reception unit 29 is preferably provided on the gate 31 or in the vicinity of the gate 31. In this embodiment, the UHF reception unit 29 is provided on the gate 31.

The wireless tag 1 includes a UHF antenna 11 and a UHF transmission circuit 12. The wireless tag 1 also includes a UHF transmission unit (tag-side transmission unit) 18 that transmits a UHF signal to the data collection device 2, an LF antenna 13, and an LF reception circuit 14. The wireless tag 1 further includes an LF reception unit (tag-side reception unit) 19 that receives an LF signal transmitted from the data collection device 2, a control unit (controller) 15, a storage unit (storage) 16 that stores information, a time measurement unit (timer) 17 that measures time, and a power unit (not shown) such as a battery.

The time measurement unit 17 is not particularly limited as long as it can measure time, and as for the precision thereof, although one with relatively high precision is preferred, one with relatively low precision may be used.

Moreover, the control unit 15 is configured, for example, by a microcomputer or the like which includes a CPU, a ROM, a RAM, and the like. The control unit 15 performs various arithmetic and determination processes in the wireless tag 1 and controls an overall operation of the wireless tag 1.

The storage unit 16 of each wireless tag 1 stores ID (tag identification) information of the corresponding wireless tag 1, and each wireless tag 1 can be specified by the ID information.

The LF band is a frequency band of 30 to 300 kHz, and the UHF band is a frequency band of 0.3 to 3 GHz. Communication in the LF band will be referred to as “LF communication,” and communication in the UHF band will be referred to as “UHF communication.”

Here, the LF communication has a characteristic such that a range (communicable range) where communication is possible is short, and the transmission power consumption is high but the reception power consumption is low. This characteristic results from the fact that since radio waves in the LF band have a long wavelength, radio-wave radiation efficiency of an antenna decreases as the size of the antenna is reduced. This is because in order to compensate for the poor radio-wave radiation efficiency, it is necessary to set the transmission power of a transmitter to be high, and thus, the power consumption of the transmitter increases. On the other hand, since the reception frequency of an LF receiver is low, the power consumption of a reception circuit can be suppressed to be low even when the reception circuit is integrated. The communicable range of the LF communication can be appropriately set to be within a range of about 1 to 5 m.

On the other hand, the UHF communication has a characteristic such that the communicable range thereof is long compared with the LF communication, and the transmission power consumption is low compared with the LF communication but the reception power consumption is high compared with the LF communication. This characteristic results from the fact that since radio waves in the UHF band have a shorter wavelength than that of the LF band, it is easy to reduce the size of an antenna while maintaining the radio-wave radiation efficiency. This is because the transmission power of a transmitter can be set to be low, and thus, the power consumption of the transmitter can be suppressed. On the other hand, since the reception frequency of a UHF receiver is higher than that of the LF receiver, the power consumption of a reception circuit increases substantially proportional to the frequency when the reception circuit is integrated. The communicable range of the UHF communication can be appropriately set to be within a range of about 5 to 50 m.

Therefore, as described above, the wireless tag 1 uses LF communication for reception and UHF communication for transmission. Thus, the power consumption of the wireless tag 1 can be reduced, and the lifespan of the power unit such as a battery embedded (mounted) therein can be extended.

Moreover, the data collection device 2 uses UHF communication for reception and LF communication for transmission. Since power can be easily supplied to the data collection device 2, there is no problem when the power consumption of the data collection device 2 is high.

In this embodiment, although the UHF band is used as a frequency band higher than the LF band, the frequency band higher than the LF band is not particularly limited, and in addition to the UHF band, a VHF band, a SHF band, and the like may be used.

Moreover, time-division multiplexing communication in the UHF band is performed between each wireless tag 1 and the data collection device 2. Thus, it is possible to prevent a collision (crosstalk) of communication between each wireless tag 1 and the data collection device 2.

In the time-division multiplexing communication, the time axis is divided into a number of time slots (sub-divided time intervals) corresponding to the number of multiplexing units for a predetermined period. A plurality of time slot numbers representing the time zone where data can be transmitted to the data collection device 2 is stored in advance in the storage unit 26 of the data collection device 2. The number of time slot numbers is preferably set to about the maximum number of workers who are expected to enter the management area 41 while holding the wireless tag 1.

Moreover, a time slot number representing the time zone where data can be transmitted to the data collection device 2 is assigned to the wireless tags 1 by the data collection device 2. The assignment of slot numbers to the wireless tags 1 is performed when the wireless tag 1 passes through the gate. The slot number information representing the slot number assigned to the wireless tag 1 is stored in the storage unit 16.

The control unit 15 of the wireless tag 1 determines the transmission time based on the time information obtained and measured by the time measurement unit 17 and the time slot number and allows the UHF transmission unit 18 to transmit data to the data collection device 2.

As shown in FIG. 3, for example, when time-division multiplexing communication is performed between three wireless tags 1a, 1b, and 1c and the data collection device 2, time slots No. 1, No. 2, and No. 3 are respectively assigned to the wireless tags 1a, 1b, and is as time slot numbers.

Each time slot of the time slots No. 1, No. 2, and No. 3 includes a transmission period where transmission (communication) is performed and a guard interval where no transmission is performed. The guard interval is provided to prevent a crosstalk resulting from errors of the time measurement unit 17. The guard interval can be appropriately set in accordance with the precision of the time measurement unit 17.

Here, the information transmitted from the wireless tag 1 to the data collection device 2 through the UHF communication may be the ID information of the wireless tag 1, for example.

In this case, the control unit 15 of the wireless tag 1 allows the UHF transmission unit 18 to transmit the ID information to the data collection device 2 in a time zone corresponding to the time slot number.

On the other hand, the data collection device 2 includes a plurality of UHF reception units (not shown) which is connected to the control unit 25 and provided at each location in the management area 41 in addition to the UHF reception unit 29. The UHF reception units may have the same function as that of the UHF reception unit 29.

The ID information transmitted from the wireless tag 1 is received by any one of the UHF reception units. In that case, the control unit 25 of the data collection device 2 determines that the worker holding the wireless tag 1 is present in the management area 41.

On the other hand, when the ID information is not received by any one of the UHF reception units, the control unit 25 determines that the worker holding the wireless tag 1 corresponding to that ID information is outside the management area 41.

As shown in FIG. 6, the wireless tag 1 preferably includes a temperature sensor 51 that detects a temperature as a sensor that detects a physical quantity. In this case, the wireless tag 1 detects an ambient temperature of the wireless tag 1 using the temperature sensor 51 and transmits information (the result of the detection by the temperature sensor 51) about the temperature detected by the temperature sensor to the data collection device 2 through the UHF communication together with the ID information. Besides the temperature sensor, the sensor that detects a physical amount may be a luminance sensor that detects a luminance, a humidity sensor that detects a humidity, and the like, for example.

Next, the operation of the office management system 100 when the wireless tag 1 passes through the gate 31 will be described.

As shown in FIG. 2, when a wireless tag 1 passes through the gate 31 to move into the management area 41, the data collection device 2 first transmits an inquiry to the wireless tag 1 so as to obtain the ID information as shown in FIG. 4. At that time, the data collection device 2 transmits the inquiry through the LF communication using the LF transmission unit 28.

When the wireless tag 1 enters the communicable range of the LF communication in the office management system 100, the wireless tag 1 receives the inquiry of the ID information using the LF reception unit 19. Thereupon, the wireless tag 1 sends back the ID information to the data collection device 2 in response to the inquiry of the ID information. At that time, the wireless tag 1 performs transmission through the UHF communication using the UHF transmission unit 18.

The data collection device 2 performs the inquiry of the ID information on a regular basis, for example, whereby the inquiry of the ID information can be transmitted to the wireless tag 1 passing through the gate 31.

The data collection device 2 receives the ID information using the UHF reception unit 29. Thus, the control unit 25 is able to realize that the wireless tag has passed through the gate 31 and moved into the management area 41. That is, the control unit 25 determines that the wireless tag 1 is positioned in the management area 41.

Subsequently, the data collection device 2 transmits time information generated by the time information generation unit 27, the time slot number information, the ID information received from the wireless tag 1 to the wireless tag 1 using the LF transmission unit 28.

The wireless tag 1 receives the time information, the time slot number information, and the ID information using the LF reception unit 19. Thereupon, the control unit 15 of the wireless tag 1 determines whether or not the ID information received from the data collection device 2 is identical to its own ID information and accepts the time information and the time slot number information when the received ID information is identical to its own ID information. Then, the wireless tag 1 sends back a normal acknowledgement to the data collection device 2 using the UHF transmission unit 18. When the ID information received from the data collection device 2 is not identical to its own ID information, the wireless tag 1 does not send back the normal acknowledgement to the data collection device 2 without accepting the time information and the time slot number information.

The data collection device 2 receives the normal acknowledgement transmitted from the wireless tag 1 using the UHF reception unit 29. Thus, the control unit 25 is able to realize that the wireless tag 1 has accepted the time information and the time slot number information. Moreover, the control unit 25 is able to realize that the wireless tag 1 has passed through the gate 31 and moved into the management area 41. That is, the control unit determines that the wireless tag 1 is positioned in the management area 41.

Moreover, the wireless tag 1 stores the time slot number information in the storage unit 16, corrects the time measurement information of the time measurement unit 17 based on the time information, and causes the time measurement unit 17 to perform time measurement. The time measurement unit 17 may perform time measurement on a regular basis. In addition, the time measurement unit 17 may perform time measurement only when the wireless tag 1 is positioned in the management area 41. In the latter case, it is possible to reduce power consumption.

The control unit 15 of the wireless tag 1 determines the transmission time based on the time information obtained and measured by the time measurement unit 17 and the time slot number and transmits data to the data collection device 2 using the UHF transmission unit 18 as described above.

The operation when the wireless tag 1 passes through the gate 31 to move out of the management area 41 is the same as above except that the time information and the time slot number information are not transmitted from the data collection device 2 to the wireless tag 1.

Here, when no ID information is received in response to the inquiry of the ID information, or no normal acknowledgement is received, the control unit 25 of the data collection device 2 is able to realize that the wireless tag 1 has passed through the gate 31 and moved out of the management area 41. That is, the control unit 25 determines that the wireless tag 1 is positioned outside the management area 41.

Next, the operation of the office management system 10 when a plurality of wireless tags 1 passes through the gate 31 at the same time will be described. In this example, a case where three wireless tags 1a, 1b, and 1c pass through the gate 31 at the same time will be described.

As shown in FIG. 5, the data collection device 2 first transmits an inquiry to the wireless tags 1a, 1b, and 1c so as to obtain the ID information. At that time, the data collection device 2 transmits the inquiry through the LF communication using the LF transmission unit 28.

When the wireless tags 1a, 1b, and 1c enter the communicable range of the LF communication, the wireless tags 1a, 1b, and 1c receive the inquiry of the ID information using the LF reception unit 19. Thereupon, the wireless tags 1a, 1b, and 1c send back the ID information to the data collection device 2 in response to the inquiry of the ID information. At that time, the wireless tag 1 performs transmission through the UHF communication using the UHF transmission unit 18.

The data collection device 2 performs the inquiry of the ID information on a regular basis, for example, whereby the inquiry of the ID information can be transmitted to the wireless tag 1 passing through the gate 31.

Here, the sending back of the ID information from the wireless tags 1a, 1b, and 1c to the data collection device 2 is performed at different times so that no collision of communication occurs. A method for realizing this includes a method of determining the sending-back (transmission) time on a random basis (sending-back standby period is determined on a random basis), a method of setting the sending-back time in accordance with the ID information, and the like, for example. In the case of determining the sending-back time on a random basis, a collision of communication may occur. However, since it takes a predetermined period of time for the wireless tags 1a, 1b, and 1c to pass through the gate 31, the collision of communication can be handled by a subsequent inquiry of the ID information from the data collection device 2, and thus no problem will occur.

The data collection device 2 receives the ID information transmitted from the wireless tag 1a, 1b, and 1c using the UHF reception unit 29. Thus, the control unit 25 is able to realize that the wireless tags 1a, 1b, and 1c have passed through the gate 31 and moved into the management area 41. That is, the control unit 25 determines that the wireless tags 1a, 1b, and 1c are positioned in the management area 41.

Subsequently, the data collection device 2 transmits the time information generated by the time information generation unit 27, the time slot number information, and the ID information received from the wireless tag 1 to the wireless tags 1a, 1b, and is in a sequential order (at different times) using the LF transmission unit 28. The sequential order is not particularly limited, and the information is preferably transmitted in the order of the receipt of the ID information. In the shown configuration, the data collection device 2 first transmits the time information, the time slot number information, and the ID information to the wireless tag 1a.

The wireless tag 1a receives the time information, the time slot number information, and the ID information using the LF reception unit 19. Thereupon, the control unit 15 of the wireless tag 1a determines whether or not the ID information received from the data collection device 2 is identical to its own ID information. In this case, since the ID information received from the data collection device 2 is identical to its own ID information, the wireless tag 1a accepts the time information and the time slot number information. Then, the wireless tag 1a sends back a normal acknowledgement to the data collection device 2 using the UHF transmission unit 18.

Moreover, the wireless tags 1b and is receive the time information, the time slot number information, and the ID information using the LF reception unit 19. Thereupon, the control unit 15 of the wireless tags 1b and 1c determine whether or not the ID information received from the data collection device 2 is identical to its own ID information. In this case, since the ID information received from the data collection device 2 is not identical to its own ID information, the wireless tags 1b and 1c do not accept the time information and the time slot number information and do not send back the normal acknowledgement to the data collection device 2.

The data collection device 2 receives the normal acknowledgement transmitted from the wireless tag 1a using the UHF reception unit 29. Thus, the control unit is able to realize that the wireless tag 1a has accepted the time information and the time slot number information. Moreover, the control unit 25 is able to realize that the wireless tag 1a has passed through the gate 31 and moved into the management area 41. That is, the control unit 25 determines that the wireless tag 1a is positioned in the management area 41.

Subsequently, the data collection device 2 transmits the time information, the time slot number information, and the ID information to the wireless tag 1b.

The wireless tag 1b receives the time information, the time slot number information, and the ID information using the LF reception unit 19. Thereupon, the control unit 15 of the wireless tag 1b determines whether or not the ID information received from the data collection device 2 is identical to its own ID information. In this case, since the ID information received from the data collection device 2 is identical to its own ID information, the wireless tag 1b accepts the time information and the time slot number information. Then, the wireless tag 1b sends back a normal acknowledgement to the data collection device 2 using the UHF transmission unit 18.

Moreover, the wireless tags 1a and 1c receive the time information, the time slot number information, and the ID information using the LF reception unit 19. Thereupon, the control unit 15 of each of the wireless tags 1a and is determines whether or not the ID information received from the data collection device 2 is identical to its own ID information. In this case, since the ID information received from the data collection device 2 is not identical to its own ID information, the wireless tags 1a and 1c do not accept the time information and the time slot number information and do not send back the normal acknowledgement to the data collection device 2.

The data collection device 2 receives the normal acknowledgement transmitted from the wireless tag 1b using the UHF reception unit 29. Thus, the control unit is able to realize that the wireless tag 1b has accepted the time information and the time slot number information. Moreover, the control unit 25 is able to realize that the wireless tag 1b has passed through the gate 31 and moved into the management area 41. That is, the control unit 25 determines that the wireless tag 1b is positioned in the management area 41.

Subsequently, the data collection device 2 transmits the time information, the time slot number information, and the ID information to the wireless tag 1c.

The wireless tag 1c receives the time information, the time slot number information, and the ID information using the LF reception unit 19. Thereupon, the control unit 15 of the wireless tag 1c determines whether or not the ID information received from the data collection device 2 is identical to its own ID information. In this case, since the ID information received from the data collection device 2 is identical to its own ID information, the wireless tag 1c accepts the time information and the time slot number information. Then, the wireless tag 1c sends back a normal acknowledgement to the data collection device 2 using the UHF transmission unit 18.

Moreover, the wireless tags 1a and 1b receive the time information, the time slot number information, and the ID information using the LF reception unit 19. Thereupon, the control unit 15 of each of the wireless tags 1a and 1b determines whether or not the ID information received from the data collection device 2 is identical to its own ID information. In this case, the ID information received from the data collection device 2 is not identical to its own ID information, the wireless tags 1a and 1b do not accept the time information and the time slot number information and do not send back the normal acknowledgement to the data collection device 2.

The data collection device 2 receives the normal acknowledgement transmitted from the wireless tag 1c using the UHF reception unit 29. Thus, the control unit is able to realize that the wireless tag 1c has accepted the time information and the time slot number information. Moreover, the control unit 25 is able to realize that the wireless tag 1c has passed through the gate 31 and moved into the management area 41. That is, the control unit 25 determines that the wireless tag 1c is positioned in the management area 41.

Moreover, the wireless tags 1a, 1b, and 1c store the time slot number information in the storage unit 16, correct the time measurement information of the time measurement unit 17 based on the time information, and cause the time measurement unit 17 to perform time measurement.

The control unit 15 of each of the wireless tags 1a, 1b, and 1c determines the transmission time based on the time information obtained and measured by the time measurement unit 17 and the time slot number and transmits data to the data collection device 2 using the UHF transmission unit 18 as described above.

The operation when the wireless tags 1a, 1b, and 1c pass through the gate 31 to move out of the management area 41 is approximately the same as above except that the time information and the time slot number information are not transmitted from the data collection device 2 to the wireless tags 1a, 1b, and 1c.

Here, when no ID information is received in response to the inquiry of the ID information, or no normal acknowledgement is received, the control unit 25 of the data collection device 2 is able to realize that the wireless tags 1a, 1b, and 1c have passed through the gate 31 and moved out of the management area 41. That is, the control unit 25 determines that the wireless tags 1a, 1b, and 1c are positioned outside the management area 41.

Next, an example of the operation performed by the office management system 100 will be described.

### Configuration Example 1

In Configuration Example 1, a case where the office management system 100 shown in FIG. 1 performs the management of security of personal computers of each worker in the management area will be described.

First, the data collection device 2 of the office management system 100 includes a plurality of UHF reception units in addition to the UHF reception unit 29, and the plurality of UHF reception units is connected to the control unit 25 and provided in the vicinity of personal computers used by each worker in the management area 41. In this case, the number of personal computers may be identical to the number of UHF reception units, or may not be. Moreover, the UHF reception units may have the same function as that of the UHF reception unit 29. In addition, the data collection device 2 is connected to each personal computer, and the control unit 25 of the data collection device 2 is able to switch the state of each personal computer between a state (active state) where the personal computer receives operations from an operation unit (such as a keyboard or a mouse) and a state (sleep state) where the personal computer does not receive the operations.

As described above, the control unit 15 of each wireless tag 1 transmits the ID information to the data collection device 2 in a time zone corresponding to the time slot number. In the following description, the management of security of a personal computer used by a worker holding a predetermined wireless tag 1 will be described as a representative example.

First, when a worker holding a wireless tag 1 is positioned in the vicinity of a personal computer used by the worker, that is, the worker is positioned within the communicable range of the UHF communication in the office management system 100, the ID information transmitted from the wireless tag 1 is received by a UHF reception unit that is provided in the vicinity of the personal computer. Thus, the control unit 25 of the data collection device 2 is able to realize that the wireless tag 1 is positioned in the vicinity of the personal computer, that is, the worker holding the wireless tag 1 is positioned in the vicinity of the personal computer used by that worker. In this case, when the personal computer is started up, the control unit 25 maintains the state where the personal computer receives operations from the operation unit.

On the other hand, when the worker holding the wireless tag 1 moves away from the personal computer used by the worker to be positioned out of the communicable range of the UHF communication in the office management system 100, the ID information transmitted from the wireless tag 1 is not received by a UHF reception unit that is provided in the vicinity of the personal computer. Thus, the control unit 25 of the data collection device 2 is able to realize that the wireless tag 1 is not positioned in the vicinity of the personal computer, that is, the worker holding the wireless tag 1 is not positioned in the vicinity of the personal computer used by the worker. In this case, when the personal computer is started up, the control unit 25 switches the state of the personal computer to a state where the personal computer does not receive operations from the operation unit. Subsequently, when a UHF reception unit provided in the vicinity of the personal computer receives the ID information transmitted from the wireless tag 1, the control unit 25 switches the state of the personal computer to a state where the personal computer receives operations from the operation unit. In this way, the security of each personal computer can be managed.

### Configuration Example 2

In Configuration Example 2, a case where the office management system 100 shown in FIG. 6 controls the temperature in the vicinity of each worker in the management area will be described.

First, the data collection device 2 of the office management system 100 includes a plurality of UHF reception units in addition to the UHF reception unit 29, and the plurality of UHF reception units is connected to the control unit 25 and provided at each location in the management area 41. The UHF reception units may have the same function as that of the UHF reception unit 29. Moreover, an air-conditioner is connected to the data collection device 2 so as to warm up and cool down the inside of the management area 41, and the air-conditioner is controlled by the control unit 25 of the data collection device 2.

As described above, each wireless tag 1 detects an ambient temperature of the wireless tag 1 using the temperature sensor 51 and transmits information (temperature information) about the temperature detected by the temperature sensor 51 to the data collection device 2 together with the ID information in a time zone corresponding to the time slot number. In the following description, the control of temperature in the vicinity of a worker holding a predetermined wireless tag 1 will be described as a representative example.

First, the ID information and the temperature information transmitted from the wireless tag 1 are received by the UHF reception unit that is provided in the vicinity of a worker holding the wireless tag 1. Thus, the control unit 25 of the data collection device 2 is able to realize that the temperature in the vicinity of the worker.

Subsequently, the control unit 25 controls an air-conditioner based on the temperature information so that the temperature in the vicinity of the worker reaches a target temperature. In this way, the temperature in the vicinity of each worker in the management area can be controlled.

As described above, according to this office management system 100, since time-division multiplexing communication is performed between each wireless tag 1 and the data collection device 2, it is possible to prevent a collision of communication between each wireless tag 1 and the data collection device 2.

Moreover, since the reception side of the wireless tag 1 receives data through the LF communication, it is possible to reduce the power consumption of the wireless tag 1 and extend the lifespan of the power unit such as a battery embedded therein.

### Second Embodiment

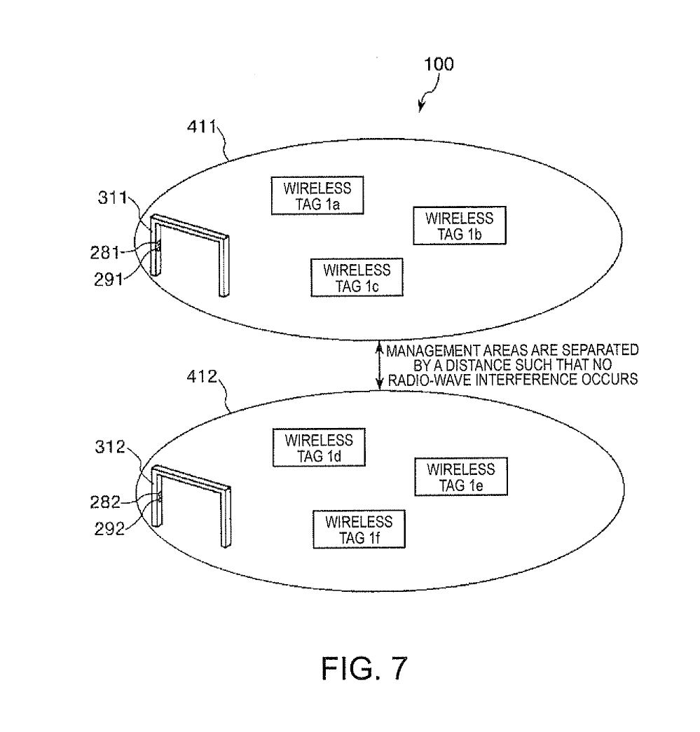

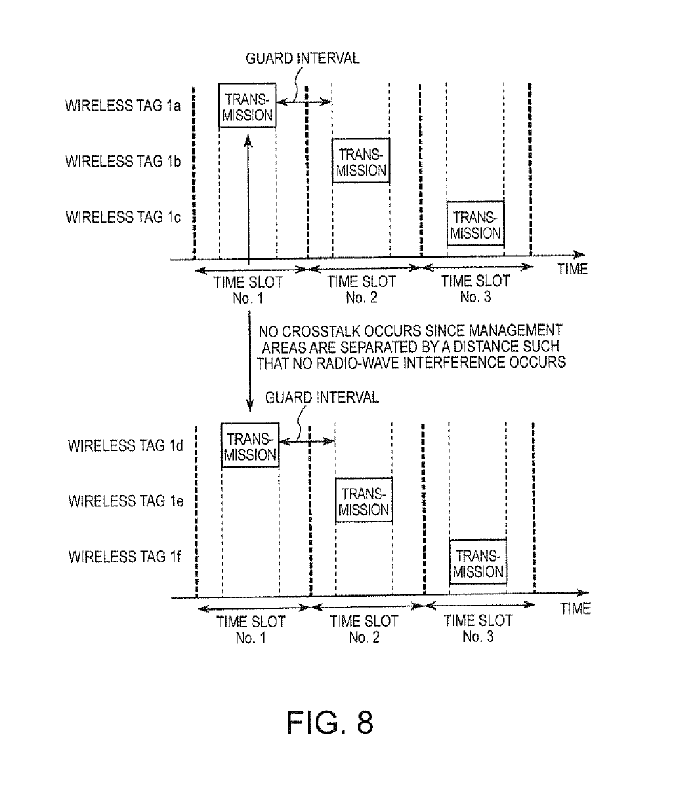

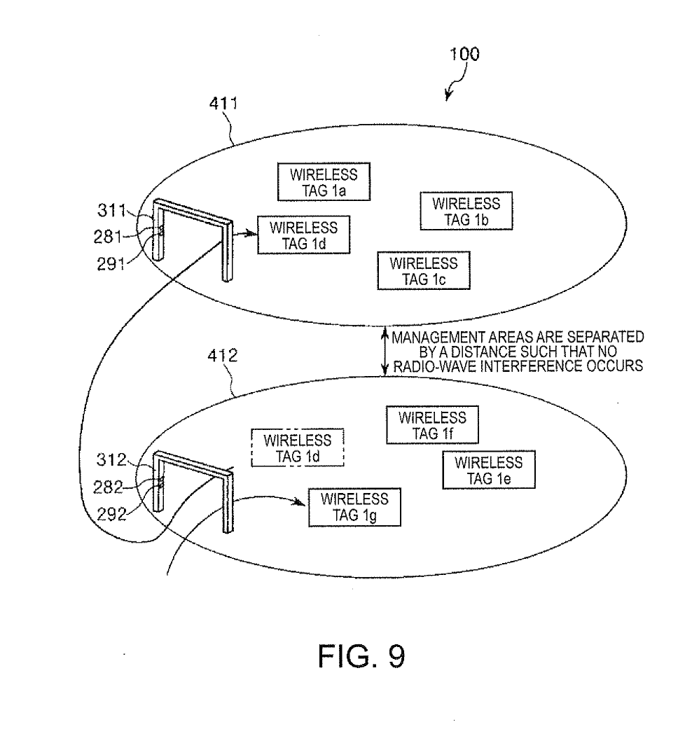

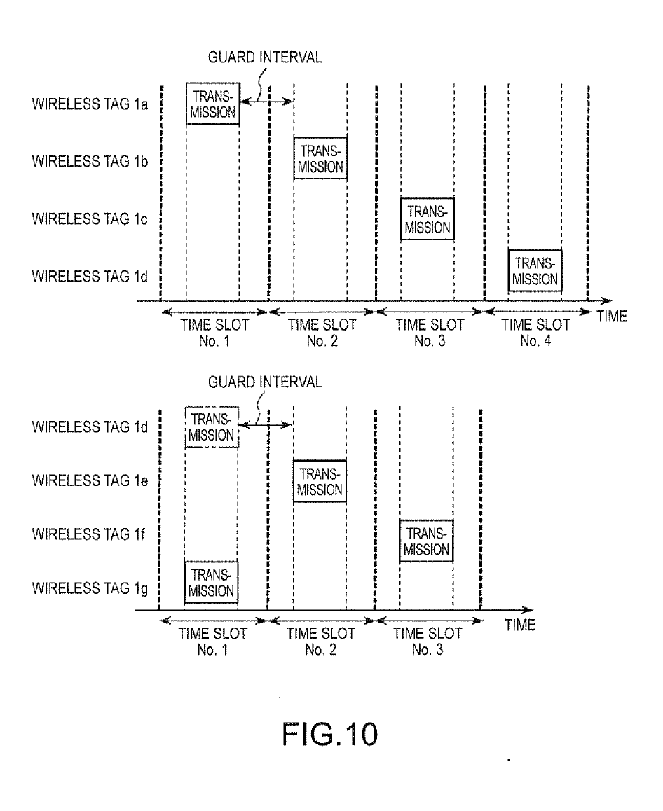

FIG. 7 is a diagram schematically showing a second embodiment in which the data collection system of the invention is applied to an office management system. FIG. 8 is a diagram showing time slots in the office management system shown in FIG. 7. FIG. 9 is a diagram schematically showing a second embodiment in which the data collection system of the invention is applied to an office management system. FIG. 10 is a diagram showing time slots in the office management system shown in FIG. 9.

In the second embodiment, the difference from the first embodiment will be mainly described, and redundant description of the same or similar matters will be omitted.

As shown in FIG. 7, in the office management system 100 of the second embodiment, two management areas (first and second management areas) 411 and 412 are set as the management area managed by the data collection device 2. The management areas 411 and 412 are set such that each point in the management area 411 and each point in the management area 412 are separated by a distance where the UHF communication is not possible in the office management system 100. That is, the management areas 411 and 412 are separated by a distance such that the UHF signals used in the office management system 100 do not interfere with each other.

Moreover, gates 311 and 312 are provided as the entrances of the management areas 411 and 412, respectively. The gate 311 is provided with an LF transmission unit 281 and a UHF reception unit 291, and the gate 312 is provided with an LF transmission unit 282 and a UHF reception unit 292. The LF transmission units 281 and 282 may have the same function as that of the LF transmission unit 28. Moreover, the UHF reception units 291 and 292 may have the same function as that of the UHF reception unit 29.

In this office management system 100, as shown in FIG. 8, the time slot numbers are set to be shared by the wireless tags 1a, 1b, and 1c positioned in the management area 411 and the wireless tags 1d, 1e, and 1f positioned in the management area 412. That is, the same time slot No. 1 is set for the wireless tags 1a and 1d, the same time slot No. 2 for the wireless tags 1b and 1e, and the same time slot No. 3 for the wireless tags 1c and 1f. By doing so, the time slot numbers can be effectively used. On the other hand, since the UHF communication is not possible between each point in the management area 411 and each point in the management area 412, even when the time slot numbers are set so as to be shared, no crosstalk occurs, and thus, no problem will occur.

It may be configured so that time-division multiplexing communication is performed, and carrier waves can be communicated over a plurality of carrier frequencies while ensuring no crosstalk of the carrier waves. In this case, the time slot numbers may be set to be shared by the wireless tags in the same management area 411.

Moreover, as shown in FIG. 9, when the wireless tag 1d that has been positioned in the management area 412 moves into the management area 411, a new time slot No. 4 is assigned to the wireless tag 1d as shown in FIG. 10. Moreover, as shown in FIG. 9, when a new wireless tag 1g moves into the management area 412, the time slot No. 1 used by the wireless tag 1d is assigned to that wireless tag 1g as shown in FIG. 10. In this way, the time slot numbers can be effectively used.

According to this office management system 100, the same advantages as those of the first embodiment can be obtained.

The number of management areas is not limited to 2 and may be 3 or more.

### Third Embodiment

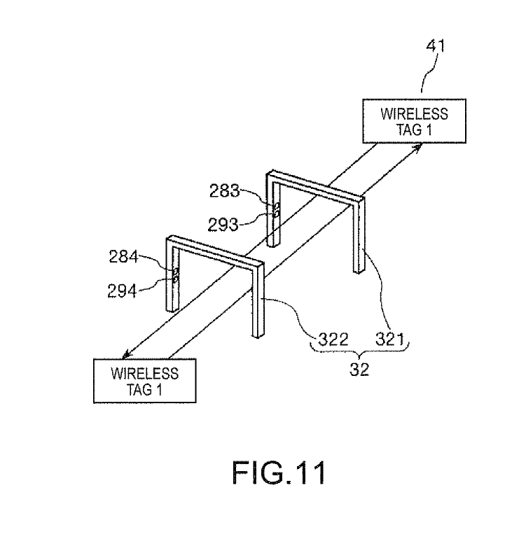

FIG. 11 is a diagram schematically showing a third embodiment, in which the data collection system of the invention is applied to an office management system, showing the configuration in the vicinity of a gate.

In the third embodiment, the difference from the first embodiment will be mainly described, and redundant description of the same or similar matters will be omitted.

As shown in FIG. 11, in the office management system 100 of the third embodiment, a gate 32 includes an inner gate 321 positioned close to the management area 41 and an outer gate 322 positioned on a side of the inner gate 321 opposite the management area 41.

The inner gate 321 is provided with an LF transmission unit (first transmission unit) 283 and a UHF reception unit (first reception unit) 293, and the outer gate 322 is provided with an LF transmission unit (second transmission unit) 284 and a UHF reception unit (second reception unit) 294. The LF transmission units 283 and 284 may have the same function as that of the LF transmission unit 28. Moreover, the UHF reception units 293 and 294 may have the same function as that of the UHF reception unit 29.

The inner gate 321 and the outer gate 322 are separated by a distance such that signals transmitted from the LF transmission unit 283 do not interfere with signals transmitted from the LF transmission unit 284.

When the wireless tag 1 moves into the management area 41 from the outside, the wireless tag 1 first performs transmission with the LF transmission unit 284 and the UHF reception unit 294 of the outer gate 322 among the LF transmission unit 284 and the UHF reception unit 294 of the outer gate 322 and the LF transmission unit 283 and the UHF reception unit 293 of the inner gate 321.

That is, in response to the inquiry of the ID information from the control unit 25 of the data collection device 2, the UHF reception unit 294 of the outer gate 322 first receives the ID information.

Thus, the control unit 25 is able to realize that the wireless tag 1 has passed through the gate 32 and moved into the management area 41 from the outside. That is, the control unit 25 determines that the wireless tag 1 is positioned in the management area 41.

Moreover, when the wireless tag 1 moves out of the management area 41, the wireless tag 1 first performs transmission with the LF transmission unit 283 and the UHF reception unit 293 of the inner gate 321 among the LF transmission unit 284 and the UHF reception unit 294 of the outer gate 322 and the LF transmission unit 283 and the UHF reception unit 293 of the inner gate 321.

That is, in response to the inquiry of the ID information from the control unit 25 of the data collection device 2, the UHF reception unit 293 of the inner gate 321 first receives the ID information.

Thus, the control unit 25 is able to realize that the wireless tag 1 has passed through the gate 32 and moved out of the management area 41. That is, the control unit 25 determines that the wireless tag 1 is positioned outside the management area 41. The control unit 25 achieves the main function of a movement direction determination unit.

Moreover, when the codes used for the transmission from the wireless tag 1 to the UHF reception unit 293 are different from the codes used for the transmission from the wireless tag 1 to the UHF reception unit 294, the control unit 25 is able to determine the entering and exiting of the wireless tag 1 into/from the management area 41 in a more reliable manner.

According to this office management system 100, the same advantages as those of the first embodiment can be obtained.

While the data collection system and the wireless tag of the invention have been described based on the embodiments, the invention is not limited to this. The configuration of each unit can be replaced with any configuration having the same function. Moreover, any other constituent elements may be added to the invention.

Moreover, the invention may be realized by any combination of two or more configurations (features) of the embodiments described above.

The entire disclosure of Japanese Patent Application No. 2010-073418, filed Mar. 26, 2010 is expressly incorporated by reference herein.

What is claimed is:

1. A data collection system comprising:
a plurality of wireless tags; and
a data collection device that performs time-division multiplexing communication with the plurality of wireless tags,
the data collection device including
a collection device-side transmission unit that is provided on a gate or in the vicinity of the gate so as to transmit an LF signal in a low-frequency band (LF band) to the wireless tag,
a collection device-side reception unit that receives a signal in a frequency band higher than the LF band transmitted from the wireless tag,
a time information generator that generates time information representing time, and
a time slot number information generator that generates time slot number information representing a time slot number which represents a time zone where data can be transmitted from the wireless tag to the data collection device,
the wireless tag including
a tag-side transmission unit that transmits a signal in a frequency band higher than the LF band to the data collection device,
a tag-side reception unit that receives an LF signal transmitted from the data collection device,
a timer that performs time measurement, and
a storage that stores information,
wherein the data collection device transmits the time slot number information and time information representing a current time to the wireless tag using the collection device-side transmission unit when the wireless tag passes through the gate, and
wherein the wireless tag receives the time slot number information and the time information using the tag-side reception unit, stores the time slot number information in the storage, corrects time measurement information of the timer based on the time information to cause the timer to perform time measurement, and transmits data to the data collection device using the tag-side transmission unit in a time zone corresponding to the time slot number.

2. The data collection system according to claim 1,
wherein ID information of the wireless tag is stored in the storage, and
wherein the wireless tag is configured to transmit the ID information to the data collection device using the tag-side transmission unit in a time zone corresponding to the time slot number.

3. The data collection system according to claim 2,
wherein the wireless tag includes a sensor that detects a physical quantity, and
wherein the wireless tag is configured to transmit the result of the detection by the sensor to the data collection device together with the ID information using the tag-side transmission unit in a time zone corresponding to the time slot number.

4. The data collection system according to claim 1,
wherein a management area which is managed by the data collection device and to/from which entering and exiting through the gate is allowed is set, and
wherein the data collection device includes a determination unit that determines whether or not the wireless tag is positioned in the management area.

5. The data collection system according to claim 1,
wherein a management area which is managed by the data collection device and to/from which entering and exiting through the gate is allowed is set,
wherein the gate includes an inner gate that is positioned close to the management area and an outer gate that is positioned on a side of the inner gate opposite the management area,
wherein the collection device-side transmission unit includes a first transmission unit that is provided on the inner gate or in the vicinity of the inner gate and a second transmission unit that is provided on the outer gate or in the vicinity of the outer gate,
wherein the collection device-side reception unit includes a first reception unit that is provided on the inner gate or in the vicinity of the inner gate and a second reception unit that is provided on the outer gate or in the vicinity of the outer gate, and
wherein the data collection device includes a movement direction determination unit that determines a movement direction of the wireless tag based on information received by the collection device-side reception unit when the wireless tag passes through the gate.

6. The data collection system according to claim 1,
wherein a first management area and a second management area which are managed by the data collection device and which are separated by a distance such that signals in a frequency band higher than the LF band do not interfere with each other are set, and
wherein the time slot numbers are set to be shared by the wireless tag positioned in the first management area and the wireless tag positioned in the second management area.

7. A wireless tag that performs time-division multiplexing communication with a data collection device, comprising:
a tag-side transmission unit that transmits a signal in a frequency band higher than a low-frequency (LF) band to the data collection device;
a tag-side reception unit that receives an LF signal transmitted from the data collection device;
a timer that performs time measurement; and
a storage that stores information.

8. The wireless tag according to claim 7,
wherein the wireless tag includes a sensor that detects a physical quantity.
